(19) United States
(12) Patent Application Publication
(10) Pub. No.: US 2025/0045100 A1
(43) Pub. Date: Feb. 6, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Takeo HOSOMI, Tokyo (JP)

(73) Assignee: NEC Corporation, Tokyo (JP)

(21) Appl. No.: 18/780,953

(22) Filed: Jul. 23, 2024

(30) Foreign Application Priority Data
Aug. 3, 2023 (JP) 2023-127252

(51) Int. Cl. G06F 9/48; G06F 9/50

(52) U.S. Cl. CPC G06F 9/4881; G06F 9/5083

(57) ABSTRACT

An information processing apparatus includes: a calculation unit calculates a cloud appropriateness value using a cost when a cloud is used for a scheduling-target job and an index indicative of a quantity of all jobs that are yet to be allocated to a server and waiting to be scheduled; and a determination unit determines, in accordance with the cloud appropriateness value, whether or not the scheduling-target job is to be offloaded to the cloud.

### CROSS-REFERENCE TO RELATED APPLICATION

This application is based upon and claims the benefit of priority from Japanese patent applications No. 2023-127252, filed on Aug. 3, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium in which cloud bursting is used.

### 2. Background Art

If a server included in a High-Performance Computing (HPC) system is under high load (if load is high), the wait time from the submission of a job to the start of processing may be extended. In view of this, techniques such as cloud bursting are disclosed as techniques for reducing the wait time. In cloud bursting, for example, it is determined whether the job can be executed using an available server included in a cloud that can communicate with the HPC system, and, if so, processing of the job is executed using the available server.

As a related technique, Cited Document 1 (Japanese Patent Laid-Open Publication No. 2021-197039) discloses a burstable instance recommendation apparatus that appropriately recommends burstable instances that are candidate migration destinations of an instance.

In order to reduce the mean wait time of the server in the HPC system, it would be sufficient to increase the amount of processing executed by the cloud. However, an increase in the amount of processing executed by the cloud would lead to an increase in cloud cost. That is, there is a trade-off relationship between mean wait time and cloud cost.

Note that techniques such as that disclosed in above-described Cited Invention 1 do not improve the trade-off relationship between mean wait time and cloud cost.

### SUMMARY OF THE INVENTION

An example object of the present disclosure is to improve the trade-off relationship between mean wait time and cloud cost.

In order to achieve the example object described above, an information processing apparatus according to an example aspect includes:
a calculation unit calculates a cloud appropriateness value using a cost when a cloud is used for a scheduling-target job and an index indicative of a quantity of all jobs that are yet to be allocated to a server and waiting to be scheduled; and
a determination unit determines, in accordance with the cloud appropriateness value, whether or not the scheduling-target job is to be offloaded to the cloud.

Also, in order to achieve the example object described above, an information processing method that is performed by a information processing apparatus according to an example aspect includes:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.

Furthermore, in order to achieve the example object described above, a computer-readable recording medium according to an example aspect includes a program recorded on the computer-readable recording medium, the program including instructions that cause the computer to carry out:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.

As described above, according to the present disclosure, the trade-off relationship between mean wait time and cloud cost can be improved.

### BRIEF DESCRIPTION OF THE DRAWINGS

FIG. 1 is a diagram for describing an example of the configuration of the information processing apparatus.

FIG. 2 is a diagram for describing an example of a configuration of a system including the information processing apparatus.

FIG. 3 is a diagram for describing an example of the operations of the information processing apparatus.

FIG. 4 is a diagram illustrating relationships between wait time and cost.

FIG. 5 is a diagram illustrating relationships between wait time and cost.

FIG. 6 is a diagram illustrating an example of a computer that realizes the information processing apparatus in the example embodiment.

### EXEMPLARY EMBODIMENT

In the following, an example embodiment will be described with reference to the drawings.

Note that, in the drawings described in the following, the same reference symbol is given to elements having the same function or corresponding functions, and repetitive description thereof may be omitted.

### Example Embodiment

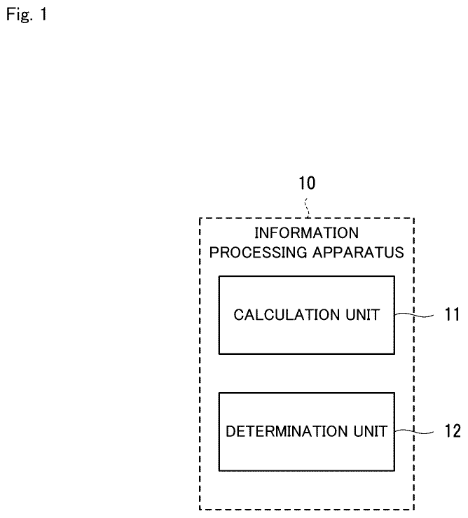

A configuration of an information processing apparatus in the example embodiment will be described with reference to FIG. 1. FIG. 1 is a diagram for describing an example of the configuration of the information processing apparatus.

### [Apparatus Configuration]

In the example in FIG. 1, an information processing apparatus 10 improves the trade-off relationship between mean wait time and cloud cost. Furthermore, in the example in FIG. 1, the information processing apparatus 10 includes a calculation unit 11 and a determination unit 12.

The calculation unit 11 calculates a cloud appropriateness value using a cost (cloud cost) when a cloud (cloud server) is used for a scheduling-target job and an index indicative of a quantity of all jobs that are yet to be allocated to a server and waiting to be scheduled.

Specifically, the index indicates the quantity of all jobs that have been submitted from terminal devices and that are yet to be allocated to the server. Furthermore, as job timings, there are timings of submission, allocation, and completion, for example. The timing of submission is the timing when a terminal submits a job to the information processing apparatus in an HPC center. The timing of allocation is the timing when the job submitted to the information processing apparatus is allocated to the server, and execution of the job is started by the server. The timing of completion is the timing when the execution of the job executed by the server is completed.

The scheduling-target job is one of a set of jobs in a wait time. Await time is the amount of time from the timing of submission to the timing of allocation.

The determination unit 12 determines, in accordance with the cloud appropriateness value, whether or not the scheduling-target job is to be offloaded to a cloud.

The jobs are jobs that have been submitted to the information processing apparatus 10 from a plurality of terminal devices. For example, a job includes information such as a program and data for executing the job using servers and a cloud, the number of servers used to execute the program (required server count), and the amount of time necessary to execute the program (required amount of time).

For example, the cost (cloud cost) is the usage fee of the cloud (cloud server). The cloud appropriateness value is information used to improve the trade-off relationship between wait time and cost, and is information for determining whether or not to offload the job to the cloud.

Because a cloud appropriateness value that is calculated using a cost when a cloud is used for a scheduling-target job and an index indicative of a quantity of all jobs that are waiting to be scheduled is used in the example embodiment as described above, the trade-off relationship between wait time and cloud cost can be improved.

### [System Configuration]

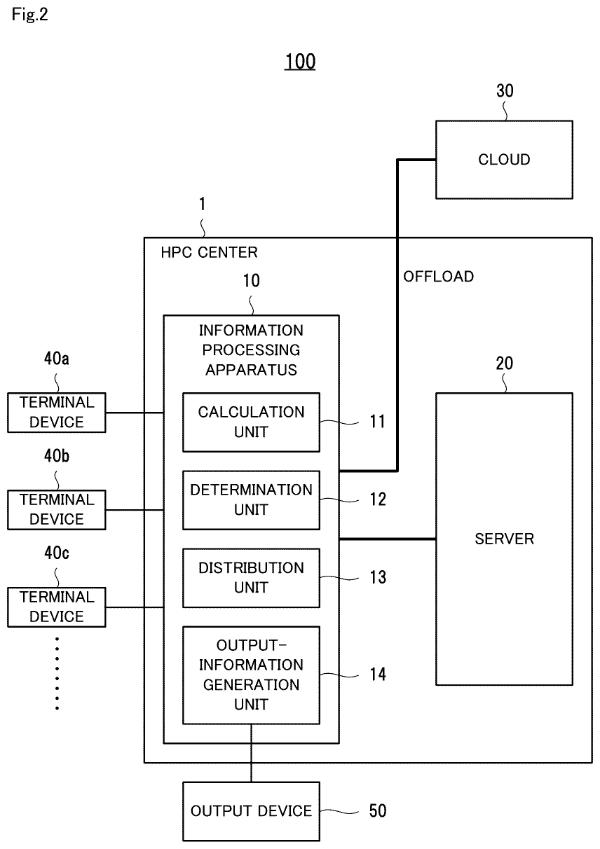

In the example in FIG. 2, the configuration of the information processing apparatus 10 in the example embodiment will be described in detail. FIG. 2 is a diagram for describing an example of a configuration of a system including the information processing apparatus.

In the example in FIG. 2, a system 100 at least includes an HPC center 1, a cloud 30, terminal devices 40 (40a, 40b, 40c, . . . ), and an output device 50. In the example in FIG. 2, the HPC center 1 at least includes the information processing apparatus 10 and a server 20. Note that the information processing apparatus 10, the server 20, the cloud 30, and the terminal devices 40 are connected via a communication network.

For example, the network is a conventional network that is constructed using a communication line such as the Internet, a Local Area Network (LAN), a dedicated line, a telephone line, an enterprise intranet, a mobile communication network, Bluetooth (registered trademark), or Wireless Fidelity (WiFi).

For example, the information processing apparatus 10 is a central processing unit (CPU), a programmable device such as a field-programmable gate array (FPGA), a graphics processing unit (GPU), or an information processing apparatus such as a circuit or a scheduler having one or more of a CPU, a programmable device, and a GPU installed therein.

The server 20 includes one or more servers. Furthermore, for example, each of the servers constituting the server 20 is a CPU, a programmable device such as an FPGA, a GPU, or an information processing apparatus such as a circuit having one or more of a CPU, a programmable device, and a GPU installed therein.

The cloud 30 includes one or more servers. Furthermore, for example, each of the servers constituting the cloud 30 is a CPU, a programmable device such as an FPGA, a GPU, or an information processing apparatus such as a circuit or a server computer having one or more of a CPU, a programmable device, and a GPU installed therein.

Each of the terminal devices 40 (40a, 40b, 40c, . . . ) is an information processing device such as a personal computer or a mobile terminal having installed therein a CPU and/or an FPGA.

The output device 50 acquires the later-described output information, which has been converted into an outputtable format, and outputs image(s), sound, etc., generated based on the output information. For example, the output device 50 is an image display device in which liquid crystal, organic electroluminescence (EL), or a cathode ray tube (CRT) is used, or the like. Furthermore, the image display device may include a sound output device such as a speaker or the like. Note that the output device 50 may be a printing device such as a printer.

The information processing apparatus will be described in detail.

The information processing apparatus 10 includes the calculation unit 11, the determination unit 12, a distribution unit 13, and an output-information generation unit 14. First, the operations of the calculation unit 11 and the determination unit 12 will be described with reference to the following examples (1) to (4).

(1) A case will be described in which the cost and the number of all of the jobs that have been submitted and are yet to be allocated (from the timing of submission to the timing of allocation) are used. In a case in which the index is the number Jk of all of the jobs that have been submitted and are yet to be allocated, the calculation unit 11 calculates a cloud appropriateness value Ca1 (=Jk/Cc) by dividing the number Jk of all of the jobs by the cost (cloud cost) Cc of the target of scheduling.

The determination unit 12 determines whether or not the scheduling-target job is to be offloaded to the cloud 30 based on the cloud appropriateness value Ca1 and a preset first threshold Th1. Note that, for example, the first threshold Th1 is determined by an experiment, simulation, or the like. Note that the first threshold Th1 may be set manually by an administrator or the like.

(2) A case will be described in which the cost and the sum of resource amounts required by all of the jobs that have been submitted and are yet to be allocated are used. In a case in which the index is the sum SRa (=ΣRak (k=1, 2, . . . , n)=Ra1+Ra2+ . . . +Ran, where n is a positive integer) of resource amounts Rak required by all of the jobs that have been submitted and are yet to be allocated, the calculation unit 11 calculates a cloud appropriateness value Ca2 (=SRa/Cc) by dividing the sum SRa of resource amounts required by all of the jobs by the cost (cloud cost) Cc.

For example, a resource amount is a value Ra (=Rsn×Rst) obtained by multiplying the required number of servers (required server count) Rsn and the amount of time necessary to process the requested job (required amount of time) Rst, which are included in a job.

The determination unit 12 determines whether or not the scheduling-target job is to be offloaded to the cloud 30 based on the cloud appropriateness value Ca2 and a preset second threshold Th2. Note that, for example, the second threshold Th2 is determined by an experiment, simulation, or the like. Note that the second threshold Th2 may be set manually by an administrator or the like.

(3) A case will be described in which the number of all of the jobs that have been submitted and are yet to be allocated, and a resource amount required by the scheduling-target job are used. In a case in which the index is the number Jk of all of the jobs that have been submitted and are yet to be allocated, the calculation unit 11 calculates a cloud appropriateness value Ca3 (=Jk/Rak) by dividing the number Jk of all of the jobs by a resource amount Rak required by the scheduling-target job.

The resource amount Rak is the resource amount required if the scheduling-target job is executed using the cloud 30.

The determination unit 12 determines whether or not the scheduling-target job is to be offloaded to the cloud 30 based on the cloud appropriateness value Ca3 and a preset third threshold Th3. Note that, for example, the third threshold Th3 is determined by an experiment, simulation, or the like. Note that the third threshold Th3 may be set manually by an administrator or the like.

(4) A case will be described in which the sum of resource amounts required by all of the jobs, and the resource amount required by the scheduling-target job are used. In a case in which the index is the sum SRa of resource amounts required by all of the jobs, the calculation unit 11 calculates a cloud appropriateness value Ca4 (=SRa/Rak) by dividing the sum SRa of resource amounts required by all of the jobs by the resource amount Rak required by the scheduling-target job.

The determination unit 12 determines whether or not the scheduling-target job is to be offloaded to the cloud 30 based on the cloud appropriateness value Ca4 and a preset fourth threshold Th4. Note that, for example, the fourth threshold Th4 is determined by an experiment, simulation, or the like. Note that the fourth threshold Th4 may be set manually by an administrator or the like.

If the determination unit 12 determines that the scheduling-target job is to be offloaded to the cloud 30, the distribution unit 13 transmits the scheduling-target job to the cloud 30. On the other hand, if the determination unit 12 determines that the scheduling-target job is not to be offloaded to the cloud 30, the distribution unit 13 transmits the scheduling-target job to the server 20.

The output-information generation unit 14 generates output information to be displayed on the output device 50 by combining at least one or more of the number of all of the jobs, the sum of resource amounts required by all of the jobs, the cost, the resource amount required by the scheduling-target job, the cloud appropriateness value, information about the scheduling-target job, the result of the determination by the determination unit 12, and time. Then, the output-information generation unit 14 outputs the output information to the output device 50. Note that the output-information generation unit 14 need not be provided in the information processing apparatus 10.

### [Apparatus Operations]

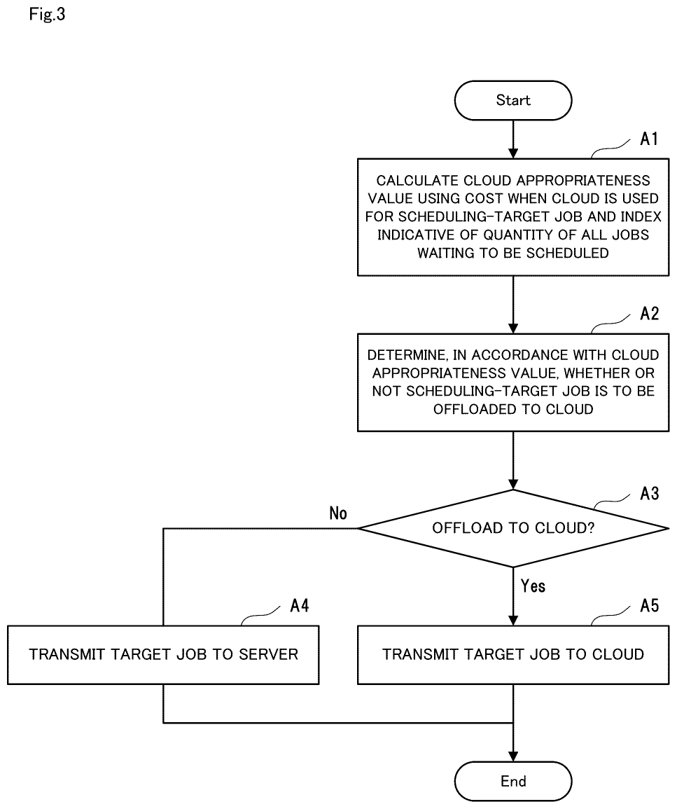

Next, operations of the information processing apparatus in the example embodiment will be described with reference to FIG. 3. FIG. 3 is a diagram for describing an example of the operations of the information processing apparatus. Drawings will be referred to as needed in the following description. Furthermore, in the example embodiment, an information processing method is implemented by causing the information processing apparatus to operate. Accordingly, the following description of the operations performed by the information processing apparatus is substituted for the description of the information processing method in the example embodiment.

In the example in FIG. 3, first, the calculation unit 11 calculates a cloud appropriateness value using a cost (cloud cost) when the cloud 30 is used for a scheduling-target job and an index indicative of a quantity of all jobs waiting to be scheduled (step A1).

Next, the determination unit 12 determines, in accordance with the cloud appropriateness value, whether or not the scheduling-target job is to be offloaded to the cloud 30 (step A2).

Steps A1 and A2 will be described with reference to the following examples (1) to (4).

(1) A case will be described in which, in steps A1 and A2, the cost and the number of all of the jobs that have been submitted and are yet to be allocated (from the timing of submission to the timing of allocation) are used. In step A1 in (1), in a case in which the index is the number Jk of all of the jobs that have been submitted and are yet to be allocated, the calculation unit 11 calculates a cloud appropriateness value Ca1 (=Jk/Cc) by dividing the number Jk of all of the jobs by the cost (cloud cost) Cc of the target of scheduling.

In step A2 in (1), the determination unit 12 determines whether or not the scheduling-target job is to be offloaded to the cloud 30 based on the cloud appropriateness value Ca1 and the preset first threshold Th1.

(2) A case will be described in which the cost and the sum of resource amounts required by all of the jobs that have been submitted and are yet to be allocated are used. In step A1 in (2), in a case in which the index is the sum SRa (=ΣRak (k=1, 2, . . . , n)=Ra1+Ra2+ . . . +Ran, where n is a positive integer) of resource amounts Rak required by all of the jobs that have been submitted and are yet to be allocated, the calculation unit 11 calculates a cloud appropriateness value Ca2 (=SRa/Cc) by dividing the sum SRa of resource amounts required by all of the jobs by the cost (cloud cost) Cc.

In step A2 in (2), the determination unit 12 determines whether or not the scheduling-target job is to be offloaded to the cloud 30 based on the cloud appropriateness value Ca2 and the preset second threshold Th2.

(3) A case will be described in which the number of all of the jobs that have been submitted and are yet to be allocated, and a resource amount required by the scheduling-target job are used. In step A1 in (3), in a case in which the index is the number Jk of all of the jobs that have been submitted and are yet to be allocated, the calculation unit 11 calculates a cloud appropriateness value Ca3 (=Jk/Rak) by dividing the number Jk of all of the jobs by a resource amount Rak required by the scheduling-target job.

In step A2 in (3), the determination unit 12 determines whether or not the scheduling-target job is to be offloaded to the cloud 30 based on the cloud appropriateness value Ca3 and the preset third threshold Th3.

(4) A case will be described in which the sum of resource amounts required by all of the jobs, and the resource amount required by the scheduling-target job are used. In step A1 in (4), in a case in which the index is the sum SRa of resource amounts required by all of the jobs, the calculation unit 11 calculates a cloud appropriateness value Ca4 (=SRa/Rak) by dividing the sum SRa of resource amounts required by all of the jobs by the resource amount Rak required by the scheduling-target job.

In step A2 in (4), the determination unit 12 determines whether or not the scheduling-target job is to be offloaded to the cloud 30 based on the cloud appropriateness value Ca4 and the preset fourth threshold Th4.

Next, if the determination unit 12 determines that the scheduling-target job is to be offloaded to the cloud 30 (step A3: Yes), the distribution unit 13 transmits the scheduling-target job to the cloud 30 (step A5). On the other hand, if the determination unit 12 determines that the scheduling-target job is not to be offloaded to the cloud 30 (step A3: No), the distribution unit 13 transmits the scheduling-target job to the server 20 (step A4). In such a manner, the above-described processing from step A1 to step A5 is executed repeatedly.

### [Effects of Embodiment]

Because a cloud appropriateness value that is calculated using a cost when a cloud is used for a scheduling-target job and an index indicative of a quantity of all jobs that are waiting to be scheduled is used according to the example embodiment as described above, the trade-off relationship between wait time and cloud cost can be improved.

In conventional technology, the maximum of the number of servers to be temporarily used in the cloud 30 is set in advance, and a scheduling-target job is transmitted to the cloud 30 if the number of available servers in the server 20 is less than the number of servers required by the job and the number of available servers in the cloud 30, i.e., the number obtained by subtracting the number of servers that are already allocated from the maximum, is more than or equal to the number of servers required by the job.

In other words, the mean wait time can be reduced by increasing the maximum of the number of servers in the cloud 30. However, an increase in the number of servers in the cloud 30 that are used would lead to an increase in cost (cloud cost).

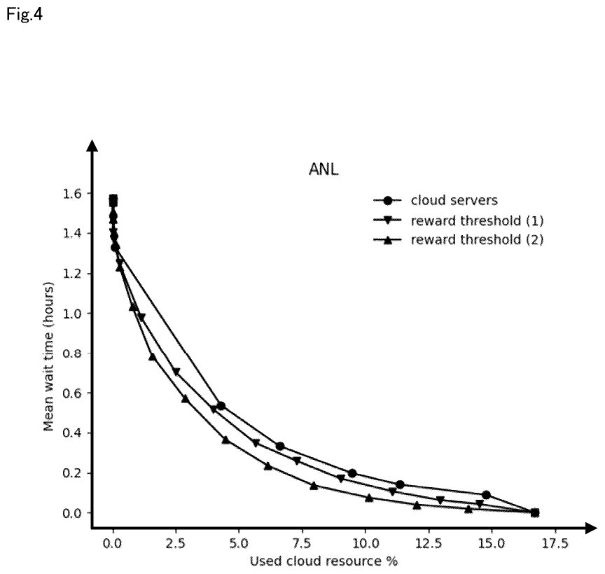

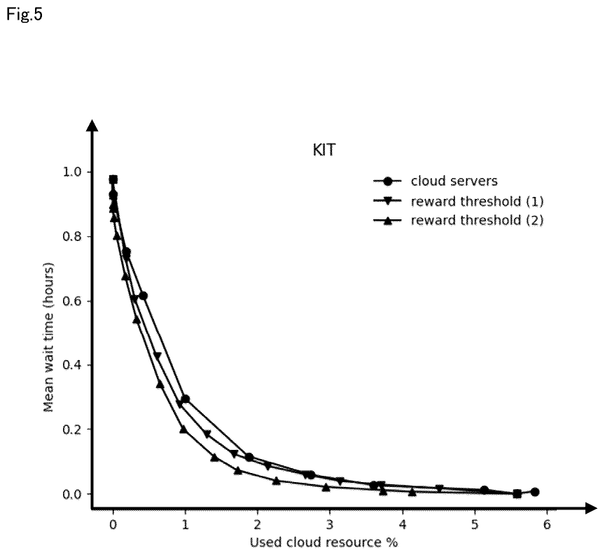

FIGS. 4 and 5 are diagrams illustrating relationships between wait time and cost. For example, the results are those obtained by performing evaluation using typical workloads. Note that, for the evaluation, the two workloads “The ANL Intrepid log” (hereinafter “ANL”) and “The KIT ForHLR II log” (hereinafter “KIT”) were used among the large number of workloads publicly disclosed in “Logs of Real Parallel Workloads from Production Systems” (<https://www.cs.huji.ac.il/labs/parallel/workload/logs.html>). FIG. 4 illustrates the results of evaluation using ANL. FIG. 5 illustrates the results of evaluation using KIT.

The line graph (•) labeled “cloud servers” shown in FIGS. 4 and 5 indicates the relationship between mean wait time and cost in a case in which conventional technology is used. Furthermore, the line graph (▾) labeled “reward threshold (1)” and the line graph (A) labeled “reward threshold (2)” shown in FIGS. 4 and 5 indicate the relationship between mean wait time and cost in cases in which the information processing apparatus 10 in the example embodiment is used.

The line graph (▾) labeled “reward threshold (1)” shown in FIGS. 4 and 5 indicates the results of evaluation for the case described in (3) described above, in which the number of all of the jobs that have been submitted and yet to be allocated, and the resource amount required by the scheduling-target job are used. Furthermore, the line graph (▴) labeled “reward threshold (2)” shown in FIGS. 4 and 5 indicates the results of evaluation for the case described in (4) described above, in which the sum of resource amounts required by all of the jobs and the resource amount required by the scheduling-target job are used.

In such a manner, according to the evaluation results in FIGS. 4 and 5, the mean wait time in relation to cost is less with the line graph (▾) labeled “reward threshold (1)” and the line graph (▴) labeled “reward threshold (2)” than with the line graph (•) labeled “cloud servers”. That is, an improvement in the trade-off relationship between wait time and cloud cost can be observed.

### [Program]

The program according to the embodiment may be a program that causes a computer to execute steps A1 to A5 shown in FIG. 3. By installing this program in a computer and executing the program, the information processing apparatus and the information processing method according to the example embodiment can be realized. In this case, the processor of the computer performs processing to function as the calculation unit 11, the determination unit 12, a distribution unit 13, and an output-information generation unit 14.

Also, the program according to the embodiment may be executed by a computer system constructed by a plurality of computers. In this case, for example, each computer may function as any of the calculation unit 11, the determination unit 12, a distribution unit 13, and an output-information generation unit 14.

### [Physical Configuration]

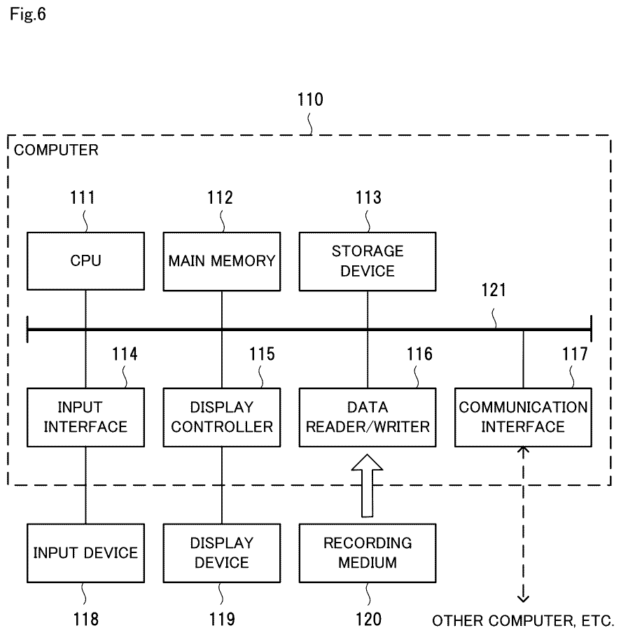

Here, a computer that realizes the information processing apparatus by executing the program according to the example embodiment and modified example will be described with reference to FIG. 6. FIG. 6 is a diagram illustrating an example of a computer that realizes the information processing apparatus in the example embodiment.

As shown in FIG. 6, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory).

Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

The information processing apparatus 10 according to the example embodiment can also be achieved using hardware corresponding to the components, instead of a computer in which a program is installed. Furthermore, a part of information processing apparatus 10 may be realized by a program and the remaining part may be realized by hardware. In the example embodiment, the computer is not limited to the computer shown in FIG. 6.

### [Supplementary Note]

The following supplementary notes are also disclosed in relation to the above-described example embodiments. Although at least part or all of the above-described example embodiments can be expressed as, but are not limited to, (Supplementary note 1) to (Supplementary note 18) described below.

### (Supplementary Note 1)

An information processing apparatus comprising:
a calculation unit calculates a cloud appropriateness value using a cost when a cloud is used for a scheduling-target job and an index indicative of a quantity of all jobs that are yet to be allocated to a server and waiting to be scheduled; and
a determination unit determines, in accordance with the cloud appropriateness value, whether or not the scheduling-target job is to be offloaded to the cloud.

### (Supplementary Note 2)

The information processing apparatus according to supplementary note 1,
wherein, in a case in which the index is the number of all of the jobs, the calculation unit calculates a cloud appropriateness value by dividing the number of all of the jobs by the cost, and
the determination unit determines whether or not the scheduling-target job is to be offloaded to the cloud based on the cloud appropriateness value and a preset first threshold.

### (Supplementary Note 3)

The information processing apparatus according to supplementary note 1,
wherein, in a case in which the index is a sum of resource amounts required by all of the jobs, the calculation unit calculates a cloud appropriateness value by dividing the sum of the resource amounts required by all of the jobs by the cost, and
the determination unit determines whether or not the scheduling-target job is to be offloaded to the cloud based on the cloud appropriateness value and a preset second threshold.

### (Supplementary Note 4)

The information processing apparatus according to supplementary note 1,
wherein, in a case in which the index is the number of all of the jobs, the calculation unit calculates a cloud appropriateness value by dividing the number of all of the jobs by a resource amount required by the scheduling-target job, and
the determination unit determines whether or not the scheduling-target job is to be offloaded to the cloud based on the cloud appropriateness value and a preset third threshold.

### (Supplementary Note 5)

The information processing apparatus according to supplementary note 1,
wherein, in a case in which the index is a sum of resource amounts required by all of the jobs, the calculation unit calculates a cloud appropriateness value by dividing the sum of the resource amounts required by all of the jobs by a resource amount required by the scheduling-target job, and
the determination unit determines whether or not the scheduling-target job is to be offloaded to the cloud based on the cloud appropriateness value and a preset fourth threshold.

### (Supplementary Note 6)

The information processing apparatus according to any one of supplementary notes 2 to 5,
wherein each of the resource amounts is a value obtained by multiplying a required number of servers and an amount of time necessary to process a requested job, each of the jobs including the required number of servers and the amount of time necessary to process the job.

### (Supplementary Note 7)

An information processing method that is performed by an information processing apparatus, the method comprising:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.

### (Supplementary Note 8)

The information processing method according to supplementary note 7,
wherein the information processing apparatus
in a case in which the index is the number of all of the jobs, calculating a cloud appropriateness value by dividing the number of all of the jobs by the cost, and
determining, whether or not the scheduling-target job is to be offloaded to the cloud based on the cloud appropriateness value and a preset first threshold.

### (Supplementary Note 9)

The information processing method according to supplementary note 7,
wherein the information processing apparatus
in a case in which the index is a sum of resource amounts required by all of the jobs, calculating a cloud appropriateness value by dividing the sum of the resource amounts required by all of the jobs by the cost, and
determining, whether or not the scheduling-target job is to be offloaded to the cloud based on the cloud appropriateness value and a preset second threshold.

### (Supplementary Note 10)

The information processing method according to supplementary note 7,
wherein the information processing apparatus
in a case in which the index is the number of all of the jobs, calculating a cloud appropriateness value by dividing the number of all of the jobs by a resource amount required by the scheduling-target job, and
determining, whether or not the scheduling-target job is to be offloaded to the cloud based on the cloud appropriateness value and a preset third threshold.

### (Supplementary Note 11)

The information processing method according to supplementary note 7,
wherein the information processing apparatus
in a case in which the index is a sum of resource amounts required by all of the jobs, calculating a cloud appropriateness value by dividing the sum of the resource amounts required by all of the jobs by a resource amount required by the scheduling-target job, and
determining, whether or not the scheduling-target job is to be offloaded to the cloud based on the cloud appropriateness value and a preset fourth threshold.

### (Supplementary Note 12)

The information processing method according to supplementary notes 2 to 5,
wherein each of the resource amounts is a value obtained by multiplying a required number of servers and an amount of time necessary to process a requested job, each of the jobs including the required number of servers and the amount of time necessary to process the job.

### (Supplementary Note 13)

A computer readable recording medium that includes a program recorded thereon, the program including instructions that cause a computer to execute processing of:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.

### (Supplementary Note 14)

The computer readable recording medium according to supplementary note 13,
wherein the program causes the computer to carry out:

The computer readable recording medium according to supplementary note 13,
wherein the program causes the computer to carry out:
in a case in which the index is the number of all of the jobs, calculating a cloud appropriateness value by dividing the number of all of the jobs by the cost, and
determining, whether or not the scheduling-target job is to be offloaded to the cloud based on the cloud appropriateness value and a preset first threshold.

### (Supplementary Note 15)

The computer readable recording medium according to supplementary note 13,
wherein the program causes the computer to carry out:
in a case in which the index is a sum of resource amounts required by all of the jobs, calculating a cloud appropriateness value by dividing the sum of the resource amounts required by all of the jobs by the cost, and
determining, whether or not the scheduling-target job is to be offloaded to the cloud based on the cloud appropriateness value and a preset second threshold.

### (Supplementary Note 16)

The computer readable recording medium according to supplementary note 13,
wherein the program causes the computer to carry out:
in a case in which the index is the number of all of the jobs, calculating a cloud appropriateness value by dividing the number of all of the jobs by a resource amount required by the scheduling-target job, and
determining, whether or not the scheduling-target job is to be offloaded to the cloud based on the cloud appropriateness value and a preset third threshold.

### (Supplementary Note 17)

The computer readable recording medium according to supplementary note 13,
wherein the program causes the computer to carry out:
in a case in which the index is a sum of resource amounts required by all of the jobs, calculating a cloud appropriateness value by dividing the sum of the resource amounts required by all of the jobs by a resource amount required by the scheduling-target job, and
determining, whether or not the scheduling-target job is to be offloaded to the cloud based on the cloud appropriateness value and a preset fourth threshold.

### (Supplementary Note 18)

The computer readable recording medium according to supplementary notes 14 to 17,
wherein each of the resource amounts is a value obtained by multiplying a required number of servers and an amount of time necessary to process a requested job, each of the jobs including the required number of servers and the amount of time necessary to process the job.

Although the invention has been described with reference to the example embodiment, the invention is not limited to the example embodiment described above. Various changes can be made to the configuration and details of the invention that can be understood by a person skilled in the art within the scope of the invention.

### INDUSTRIAL APPLICABILITY

According to the describe above, the trade-off relationship between mean wait time and cloud cost can be improved. In addition, it is useful in a field where cloud burst is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
at least one memory storing instructions; and
at least one processor configured to execute the instructions to:
calculate a cloud appropriateness value using a cost when a cloud is used for a scheduling-target job and an index indicative of a quantity of all jobs that are yet to be allocated to a server and waiting to be scheduled; and
determine, in accordance with the cloud appropriateness value, whether or not the scheduling-target job is to be offloaded to the cloud.

2. The information processing apparatus according to claim 1,
wherein the one or more processors further:
in a case in which the index is the number of all of the jobs, calculates a cloud appropriateness value by dividing the number of all of the jobs by the cost, and
determines whether or not the scheduling-target job is to be offloaded to the cloud based on the cloud appropriateness value and a preset first threshold.

3. The information processing apparatus according to claim 1,
wherein the one or more processors further:
in a case in which the index is a sum of resource amounts required by all of the jobs, calculates a cloud appropriateness value by dividing the sum of the resource amounts required by all of the jobs by the cost, and
determines whether or not the scheduling-target job is to be offloaded to the cloud based on the cloud appropriateness value and a preset second threshold.

4. The information processing apparatus according to claim 1,
wherein the one or more processors further:
in a case in which the index is the number of all of the jobs, calculates a cloud appropriateness value by dividing the number of all of the jobs by a resource amount required by the scheduling-target job, and
determines whether or not the scheduling-target job is to be offloaded to the cloud based on the cloud appropriateness value and a preset third threshold.

5. The information processing apparatus according to claim 1,
wherein the one or more processors further:
in a case in which the index is a sum of resource amounts required by all of the jobs, calculates a cloud appropriateness value by dividing the sum of the resource amounts required by all of the jobs by a resource amount required by the scheduling-target job, and
determines whether or not the scheduling-target job is to be offloaded to the cloud based on the cloud appropriateness value and a preset fourth threshold.

6. The information processing apparatus according to claim 3,
wherein each of the resource amounts is a value obtained by multiplying a required number of servers and an amount of time necessary to process a requested job, each of the jobs including the required number of servers and the amount of time necessary to process the job.

7. An information processing method in which an information processing apparatus executes processing comprising:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.

8. A non-transitory computer-readable recording medium that includes a program recorded thereon, the program including instructions that causes to carry out:
calculating a cloud appropriateness value using a cost when a cloud is used for a scheduling-target job and an index indicative of a quantity of all jobs that are yet to be allocated to a server and waiting to be scheduled; and
determining, in accordance with the cloud appropriateness value, whether or not the scheduling-target job is to be offloaded to the cloud.
